(19) United States
(12) Patent Application Publication
(10) Pub. No.: US 2006/0057443 A1
(43) Pub. Date: Mar. 16, 2006

(54) Hybrid fuel cell combining direct carbon conversion and high temperature H2 fuel cells

(75) Inventor: John F. Cooper, Oakland, CA (US)

Correspondence Address: Eddie E. Scott;Assistant Laboratory Counsel, Lawrence Livermore National Laboratory, P.O. Box 808, L-703, Livermore, CA, 94551, US

(73) Assignee: The Regents of the University of California

(21) Appl. No.: 10/942,537

(22) Filed: Sep. 15, 2004

(51) Int. Cl. H01M 8/06; H01M 16/00; H01M 8/24; H01M 8/12; H01M 8/14

(52) U.S. Cl. 429/19; 429/9; 429/30; 429/46; 429/17

(57) ABSTRACT

A hybrid power generation system for generating electrical power from a hydrocarbonaceous fuel comprising a pyrolysis unit for pyrolyzing the hydrocarbonaceous fuel to form carbon and hydrogen, a direct conversion fuel cell for converting said carbon into electrical power, and a solid oxide fuel cell for converting said hydrogen into electrical power. Electrical power is generated from a hydrocarbonaceous fuel by pyrolyzing the hydrocarbonaceous fuel to form carbon and hydrogen, introducing the carbon into a direct conversion fuel cell for producing electrical power, and introducing the hydrogen into a solid oxide fuel cell for producing electrical power.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to fuel cells and more particularly to a hybrid fuel cell.

2. State of Technology

International Patent Application No. WO 98/40922 to Procyon Power Systems Inc, published Sep. 17, 1998, for a hybrid fuel-cell electric-combustion power system provides the following state of technology information, “a procedure for generating power and a hybrid power generating system of interrelated components used to practice that procedure. The procedure involves partial pyrolysis, either by thermal or catalytic means, of a liquid or gaseous hydrocarbon to produce a gaseous stream containing hydrogen and to produce a partially de-hydrogenated intermediate fuel stream. The intermediate stream may be gaseous, liquid, or in some instances, may even be hydrogen-free and hence a solid. The hydrogen-containing stream (or hydrogen-rich gas stream) may be fed to a fuel cell to produce electric energy. The electric energy so-produced in turn may be used in an electric motor to produce mechanical power.”

United States Patent Application No. 2003/0017380 by John F. Cooper et al for a tilted fuel cell apparatus published Jan. 23, 2003 provides the following state of technology information, “High temperature, molten electrolyte, electrochemical cells have been shown to be an efficient method of producing energy particularly when the fuel source is hydrogen gas. Carbon as a fuel source in electrochemical cells has been explored.”

United States Patent Application No. 2002/0106549 by John F. Cooper et al for a fuel cell apparatus and method thereof published Aug. 8, 2002 provides the following state of technology information, “High temperature, molten electrolyte, electrochemical cells have been shown to be an efficient method of producing energy particularly when the fuel source is hydrogen gas. Carbon as a fuel source in electrochemical cells has been explored. Efficiencies of various carbon sources have been calculated based on half-cell data and have consistently been low, e.g., 50% or less. (However, more recent studies of the efficiency of assembled carbon/air cells showed that many carbon materials could deliver 80% of the HHV of the carbon as useful electric power. [Reference: Nerine J. Cherepy, Roger Krueger, Kyle Fiet, Alan Jankowski, and John F. Cooper, “Direct conversion of carbon fuels in a molten carbonate fuel cell,” paper accepted for publication in the Journal of the Electrochemical Society, 2004; see also J. F. Cooper, “Direct Conversion of Coal and Coal-Derived Carbon in Fuel Cells,” Proc. Fuel Cell Science, Engineering and Technology, 2004, paper No. Fuel Cell 2004-2495, The American Institute of Mechanical Engineers, June 2004.)

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a hybrid power generation system for generating electrical power from a hydrocarbonaceous fuel comprising a pyrolysis unit for pyrolyzing the hydrocarbonaceous fuel to form carbon and hydrogen, a direct conversion fuel cell for converting said carbon into electrical power, and a solid oxide fuel cell for converting the hydrogen into electrical power. Electrical power is generated from a hydrocarbonaceous fuel by pyrolyzing the hydrocarbonaceous fuel to form carbon and hydrogen, introducing the carbon into a direct conversion fuel cell for producing electrical power, and introducing the hydrogen into a solid oxide fuel cell for producing electrical power.

The hybrid power generation system has uses in efficient electric power generation and in broad mobile, transportable and stationary applications. The system also has uses in electric power generation at high efficiencies from coal, petroleum derived fuels, petroleum coke, and natural gas. The system can help to conserve precious fossil resources by allowing more power to be harnessed from the same amount of fuel, can help improve the environment by substantially decreasing the amount of pollutants emitted into the atmosphere per kilowatt-hour of electrical energy that is generated, and can help decrease emissions of carbon dioxide, which are largely responsible for global warming.

The hybrid power generation system can use fuel derived from many different sources, including coal, lignite, petroleum, natural gas, and even biomass (peat, rice hulls, corn husks). At the present time 90 percent of Earth's electric energy comes from the burning of fossil fuels. Half of our fossil-fuel resources is coal, and 80 percent of the coal belongs to the United States and Canada, the former Soviet Union, and China. Coal-fired plants produce 55 percent of U.S. electricity—as well as large amounts of pollutants. As a result, the vast energy reserves of coal remain underused.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates a hybrid power generation system that can be implemented by an oil refinery using heavy oil cracking fractions.

FIG. 2 provides a description of an externally reformed fuel, using feed back of the unutilized hydrogen (at 85% utilization).

FIG. 3 shows the results of an analysis superimposed on a chart from National Energy Technology Laboratory of the demands for advanced fuel cells in the 21^{st} Century.

FIG. 4 shows a system for converting natural gas, petroleum fuels, or natural gas into electrical power.

FIG. 5 shows a system for converting petroleum coke into electrical power.

FIG. 6 shows a system for converting brown coal, lignite or biomass into electrical power.

FIG. 7 shows a direct conversion fuel cell constructed in accordance with the present invention.

### DETAILED DESCRIPTION OF THE INVENTION

Referring now to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

Modern high temperature fuel cells are designed to react hydrogen and oxygen, or hydrogen derived from steam reforming of a hydrocarbon such as methane. If the methane is reformed internally to the cell, then in principle high efficiencies can be obtained (e.g., at 750° C., the product efficiency of internal reforming of methane is 57% HHV, assuming 80% voltage efficiency and 80% utilization of the methane feed. Internal reforming carries the risk of carbonization of the fuel cell electrodes, i.e., deposition of the carbon onto the electrodes. Avoiding this requires the use of extra steam (1.5× stoichiometry). The utilization is also somewhat optimistic, as the gas is diluted not only with the steam reaction product (including excess) but also with carbon dioxide and unconverted CO. External stream reforming requires excess heat or an efficient transfer of internal heat from the fuel cell to the reformer. These requirements further degrade the efficiency over that achievable with the more difficult internal reforming.

All fossil fuels contain both carbon and hydrogen. Pyrolysis is a low energy cost means of separating the hydrogen from the carbon. Applying electrochemical conversion to the carbon and the hydrogen separately, the combined system provides for an ultra-efficient conversion. Consider the following illustration, using n-decane as the hydrocarbon. This can be extended to any heavy refinery oil, to coal-bed methane, or to heavy hydrocarbons or elemental carbon extracted from coal by solvent refining or hydropyrolysis.

The heat of formation of decane is −59.67 kcal/mol:
C₁₀H₂₂=10C+11H₂ ΔH_{f}=−59.67 kcal/mol
   The heat of combustion (std. enthalpy at 298° K.) is −1632.35 kcal/mol:
C₁₀H₂₂+15.5 O₂=10CO₂+11H₂O ΔH°₂₉₈=−1632.35 kcal/mol
   (ΔH_{LHV}=−1516.63 kcal/mol)
      Thus the energy cost of pyrolysis is low: 59.67/1632.35=3.65%.

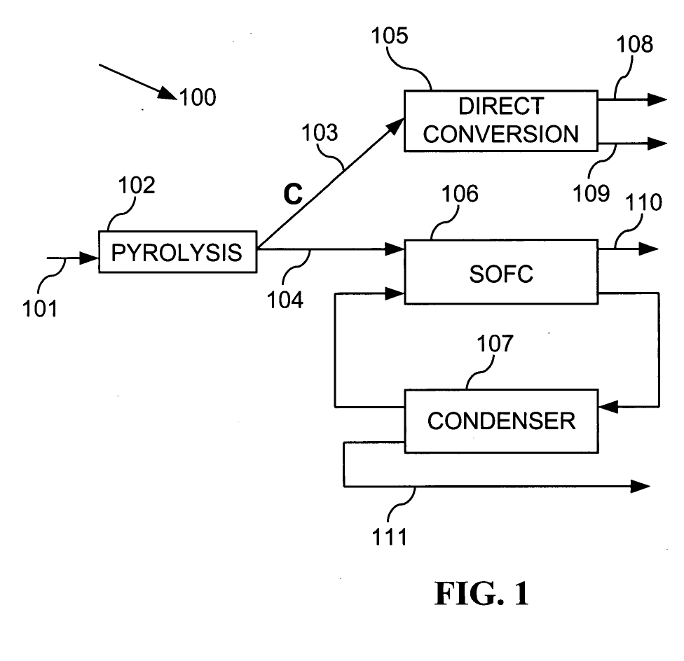

Referring now to FIG. 1, a process is illustrated that has use for example by an oil refinery using heavy oil cracking fractions. The hydrocarbon is pyrolyzed using thermal energy from any source, such as fuel oil or natural gas. The process is referred to generally by the reference numeral 100.

Table 1 below shows possible enhanced efficiency power generation through combination of Direct Conversion and SOFC in their simplest forms. The operating parameters are shown in Table 1, for one mole of decane (0.142 kg).

TABLE 1

| | Operating | | Chemical |
|---|---|---|---|
| Subsystem | conditions | Energy out/in | products |
| Direct | 800° C., E = 0.85 V, | 784.2 kcal- | 0.440 kg CO₂, |
| conversion | utilization = 1.0 | electrical | pure |
| | | 911 Wh | |
| SOFC | 800° C., E = 0.85 V, | 431.3 kcal- | 0.198 kg liquid |
| | utilization = 1.0 (with | electrical | water from |
| | condensation loop) | (501.3 Wh) | condenser |
| Pyrolyzer | 800° C.; ambient | 59.67 kcal/mole | carbon + |
| | pressure; external fired | | hydrogen |
| Total | — | 1215.4 kCal- | Pure CO₂ + |
| system | | electrical | H₂O + heat |
| | | | from cells |

The total system efficiency for this process (not counting on any internal transfer of process heat from the cell output steam and carbon dioxide) is approximated by:
Efficiency (total)=(62 E_{cell} F/4184)/(1516.63+59.67)=77% (LHV)
Efficiency (total)=(62 E_{cell} F/4184)/(1632.35+59.67)=72% (HHV)

While these efficiencies are higher than the long-range goal for advanced fuel cells, they are achieved here without any collection and internal transfer of entropic or kinetic waste heat. (If this heat is partially transferred to the pyrolyzer, then the efficiencies increase beyond the 77% LHV given above. If turbines are used, then the output increases further, at an additional capital expense). In all likelihood, the cells' product gases would merely offset the pyrolysis energy by heating the incoming fuel streams. The advantage of this process is contained in the relative simplicity of pyrolysis and in obviating the need for quantitative transfer of cell entropic and dissipative heat in order to refine the electrochemical fuel.

Referring again to FIG. 1, the system 100 will be described in greater detail. A heavy hydrocarbon 101 is decomposed into “C” carbon 103 and “H₂” hydrogen 104 through pyrolysis 102. The carbon 103 is converted to electrical power 108 in a direct conversion fuel cell 105. The hydrogen 104 is converted to electricity 110 in a solid oxide fuel cell 106 using water condenser 107 to separate steam from unutilized hydrogen and return the same to fuel cell 106. The direct conversion fuel cell 105 produces electrical power 108 and carbon dioxide 109. The solid oxide fuel cell 106 produces electrical power 110 and water 111.

The direct conversion fuel cell 105 provides a direct carbon conversion fuel cell that generates electric power from the electrochemical reaction of carbon and atmospheric oxygen. The direct conversion fuel cell 105 comprises a fuel cell housing containing an anode and a cathode. A slurry, paste or wetted aggregation is introduced into the fuel cell housing. The slurry comprises carbon 103 wetted by or immersed in a molten-salt electrolyte. The carbon is immersed in a molten-salt electrolyte consisting of a mixture of molten alkali carbonates such as (LiₐK_{b}Na_{c})₂CO₃, where (a+b+c)=1, to form a slurry, paste or wetted aggregation.

The slurry is introduced into the direct conversion fuel cell 105. The molten salt electrolyte provides a continuous electrolyte of carbon between the porous nickel plate anode current collector and a porous nickel plate cathode. An inert ceramic separator (e.g., woven alumina or zirconia fibers) saturated with the molten salt may be located between anode and cathode. The anode current collector and the cathode produce an electrical current.

The direct conversion fuel cell 105 reactions are as follows:
C+2CO₃²⁻=3 CO₂+4e⁻ anodic half-reaction, at an inert Ni or graphite current collector
O₂+2CO₂+4e⁻=2CO₃²⁻ cathode half-reaction, at a NiO-coated Ni cathode
C+O₂=CO₂ Net cell reaction, sum of the half reactions

The direct conversion fuel cell 105 in one embodiment uses particles of carbon (1-1000 micrometers) having small domains of nano-crystallinity (30-100 nanometer). The particles are distributed in a mixture of molten lithium, sodium, or potassium carbonate at a temperature of 750 to 850° C. The overall cell reaction is carbon and oxygen (from ambient air) forming carbon dioxide and electrical power. The reaction yields 80 percent of the carbon-oxygen combustion energy as electrical power. It provides up to 1 kilowatt of power per square meter of cell surface area—a rate sufficiently high for practical applications. Yet no burning or combustion of the carbon takes place.

The direct conversion fuel cell 105 is refueled by, for example, entrainment of the fine carbon particles into the cell housing in a gas such as carbon dioxide or nitrogen in such a manner that the carbon particles are immediately wetted by the molten salt upon contact and thus wetted, remain in electrical contact with the melt until consumed by anodic oxidation. The direct conversion fuel cell 105 provides a method of carbon preparation to allow instant wetting of the particles upon contact with the molten carbonate salt mixture comprising the fuel cell electrolyte.

The hydrogen 104 is converted to electrical power 110 in a solid oxide fuel cell (SOFC) 106 using water condenser 107. The solid oxide fuel cell 106 uses a hard ceramic electrolyte and operates at temperatures of 700 C up to 1,000 degrees C. (about 1,800 degrees F.). A mixture of zirconium oxide and calcium oxide or yttrium oxide form a crystal lattice, though other oxide combinations have also been used as electrolytes. The solid electrolyte is coated on both sides with specialized porous electrode materials. At these high operating temperatures, oxygen ions (with a negative charge) migrate through the crystal lattice. When a fuel gas containing hydrogen 104 is passed over the anode, a flow of negatively charged oxygen ions moves across the electrolyte to oxidize the fuel. The oxygen is supplied, usually from air, at the cathode. Electrons generated at the anode travel through an external load to the cathode, completing the circuit and supplying electric power along the way. Generating efficiencies can range up to about 60 percent based on the higher heating value of hydrogen.

Embodiments of the present invention provide an apparatus and method of achieving very high total electrochemical conversion efficiencies by (1) thermal decomposition of a heavy hydrocarbon into hydrogen and carbon, (2) separation of the hydrogen from the carbon in a gas centrifuge, and (3) respective conversion of the C and H₂ in a DCC and hydrogen fuel cell, with recovery of the unutilized hydrogen by water condensation. Using decane as a model of a heavy hydrocarbon, the total energy conversion efficiency (including pyrolysis) can be 72% HHV (77% LHV) without use of any bottoming cycles. The energy for pyrolysis of decane is very low-only 4% of its HHV. The efficiency of 77% HHV is a 25% improvement over steam reforming of the same hydrocarbon and use in a conventional fuel cell.

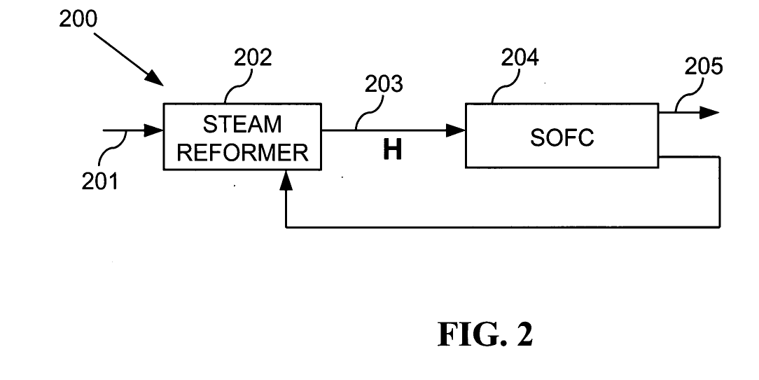

Referring now to FIG. 2, a description is provided of an externally reformed fuel, using feed back of the unutilized hydrogen (at 85% utilization). Here the efficiency is reduced from 77% LHV to 62% LHV. These assumptions are optimistic, as the hydrogen feed back cannot be readily separated from the hot mixture of gases (CO₂, H₂O and H₂) leaving the steam reformer and fuel cell, as would be required to recover the full heat of combustion. The process is referred to generally by the reference numeral 200. A heavy hydrocarbon 201 is processed in a steam reformer 202 producing “H” hydrogen-rich 203. The hydrogen is converted to electrical power 205 in a solid oxide fuel cell 204.

Clearly, both systems 100 and 200 could be enhanced with internal heat transfers or with hybridization, but Applicants are examining the simplest possible systems with the intent of keeping cost/complexity to minimum.

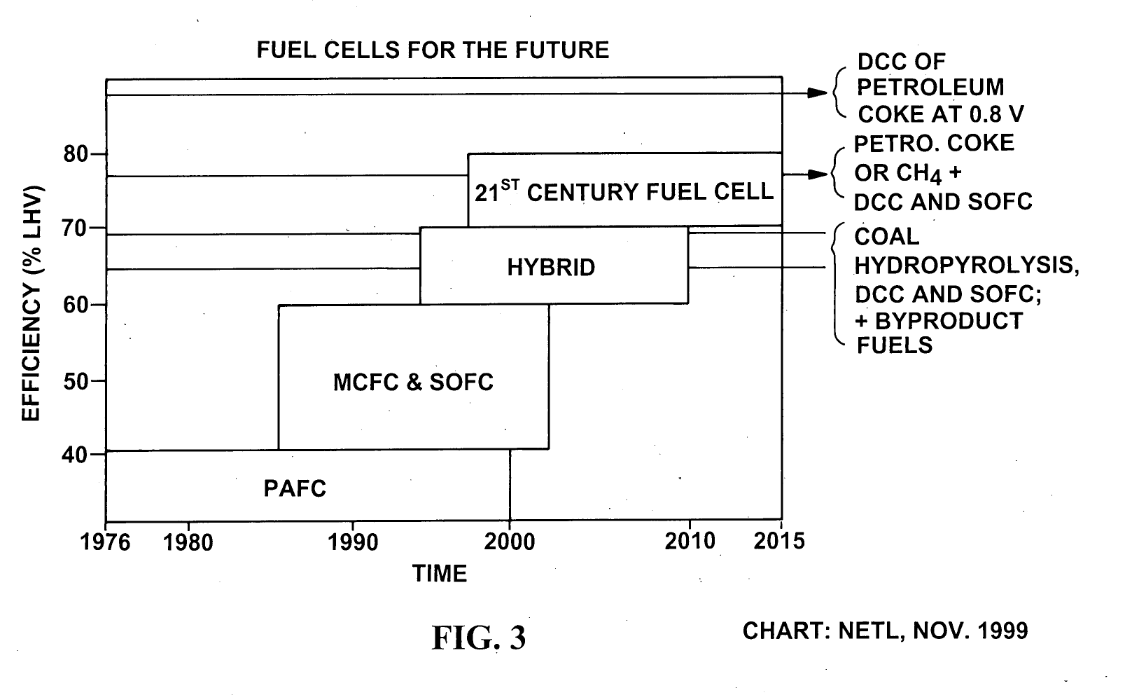

Referring now to FIG. 3, the results of Applicants' analysis are shown superimposed on NETL's view of the demands for the 21 Century Fuel Cell. It is a goal that technically is only partially defined. DOE through Fossil Energy and National Energy Technology Laboratory (formerly FETC) is seeking an ultra-high efficiency concept for its 21′ Century Fuel Cell—which is as yet only partially defined. Direct carbon conversion provides a potential route to meeting these objectives through operation on pyrolyzed hydrocarbons or in combination with advanced fuel cells for the hydrogen byproduct of pyrolysis. Applicants' route, pyrolysis followed by electrochemical conversion in fuel cells and direct conversion cells, is a contribution.

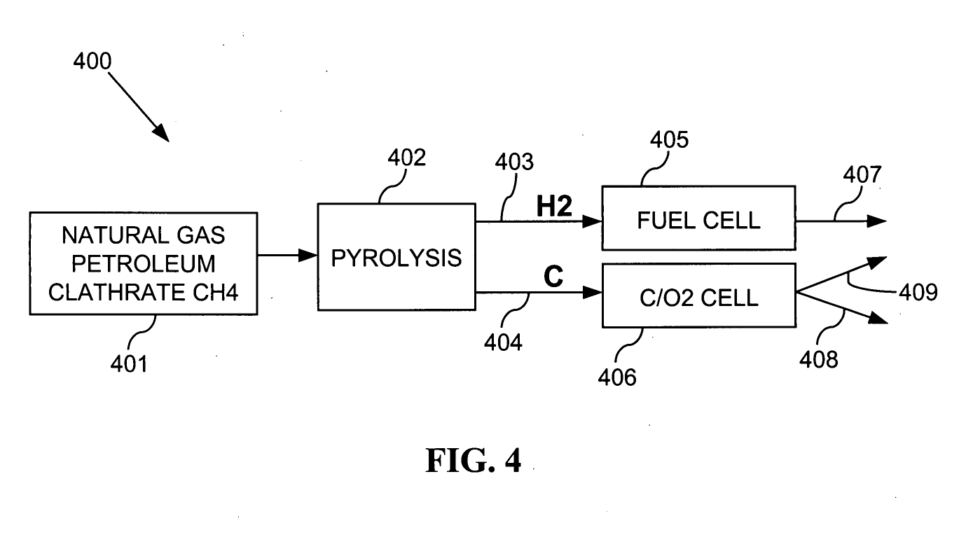

Referring now to FIG. 4, a system 400 will be described for converting natural gas, petroleum, clathrate CH₄, 401 into electrical power 407 and 409. The system is designated generally by the reference numeral 400. The natural gas, petroleum, clathrate CH₄, 401 is decomposed into “C” carbon 404 and “H₂” hydrogen 403 through pyrolysis 402. The carbon 404 is converted to electrical power 409 in a direct conversion fuel cell 406. The direct conversion fuel cell 406 produces electrical power 409 and carbon dioxide 408. The hydrogen 403 is converted to electrical power 407 in a solid oxide fuel cell 405.

The direct conversion fuel cell 406 provides a direct carbon conversion fuel cell that generates electric power 408 from the electrochemical reaction of carbon and atmospheric oxygen. The direct conversion fuel cell 406 comprises a fuel cell housing containing an anode and a cathode. A slurry or wetted aggregation is introduced into the fuel cell housing. The slurry comprises carbon 404 immersed in a molten-salt electrolyte. The carbon is immersed in a molten-salt electrolyte consisting of a mixture of molten alkali carbonates (Li,K,Na)₂CO₃ to form a slurry or wetted aggregation.

The slurry is introduced into the direct conversion fuel cell 406. The molten salt electrolyte provides a continuous electrolyte of carbon between the porous nickel plate anode current collector and a porous nickel plate cathode. An inert ceramic separator (e.g., woven alumina or zirconia fibers) saturated with the molten salt may be located between anode and cathode. The anode current collector and the cathode produce an electrical current 408.

The direct conversion fuel cell 404 reactions are as follows:
C+2CO32−=3 CO2+4e− anodic half-reaction, at an inert Ni current collector
O2+2CO2+4e−=2CO32- cathode half-reaction, at a NiO-coated Ni cathode
C+O2=CO2 Net cell reaction, sum of the half reactions
   The direct conversion fuel cell 404 in one embodiment uses aggregates of extremely fine (10- to 1,000-nanometer-diameter) carbon distributed in a mixture of molten lithium, sodium, or potassium carbonate at a temperature of 750 to 850° C. The overall cell reaction is carbon and oxygen (from ambient air) forming carbon dioxide and electrical power. The reaction yields 80 percent of the carbon-oxygen combustion energy as electrical power. It provides up to 1 kilowatt of power per square meter of cell surface are—a rate sufficiently high for practical applications. Yet no burning of the carbon takes place.

The direct conversion fuel cell 404 is refueled by, for example, entrainment of the fine carbon particles into the cell housing in a gas such as carbon dioxide or nitrogen in such a manner that the carbon particles are immediately wetted by the molten salt upon contact and thus wetted, remain in electrical contact with the melt until consumed by anodic oxidation. The direct conversion fuel cell 404 provides a method of carbon preparation to allow instant wetting of the particles upon contact with the molten carbonate salt mixture comprising the fuel cell electrolyte.

The hydrogen 403 is converted to electrical power in a solid oxide fuel cell (SOFC) 405. The solid oxide fuel cell 405 uses a hard ceramic electrolyte and operates at temperatures up to 1,000 degrees C. (about 1,800 degrees F.). A mixture of zirconium oxide and calcium oxide form a crystal lattice, though other oxide combinations have also been used as electrolytes. The solid electrolyte is coated on both sides with specialized porous electrode materials. At these high operating temperatures, oxygen ions (with a negative charge) migrate through the crystal lattice. When a fuel gas containing hydrogen 404 is passed over the anode, a flow of negatively charged oxygen ions moves across the electrolyte to oxidize the fuel. The oxygen is supplied, usually from air, at the cathode. Electrons generated at the anode travel through an external load to the cathode, completing the circuit and supplying electric power along the way. Generating efficiencies can range up to about 60 percent. An alternative to the SOFC is a molten carbonate fuel cell (MCFC) that also operates at elevated temperatures (650-750 C) and can accept hydrogen (even contaminated with CO or steam) from the pyrolysis of the hydrocarbon fuel. Low temperature Phosphoric acid (PAFC), PEM or alkaline fuel cells are also possible means of converting the hydrogen fraction, although these require heat exchangers and greater purification of the hydrogen-rich byproduct from pyrolysis.

Embodiments of the present invention provide an apparatus and method of achieving very high total electrochemical conversion efficiencies by (1) thermal decomposition of a heavy hydrocarbon into hydrogen and carbon, (2) separation of the hydrogen from the carbon in a gas centrifuge, and (3) respective conversion of the C and H₂ in a DCC and hydrogen fuel cell, with recovery of the unutilized hydrogen by water condensation. Using decane as a model of a heavy hydrocarbon, the total energy conversion efficiency (including pyrolysis) can be 72% HHV (77% LHV) without use of any bottoming cycles. The energy for pyrolysis of decane is very low-only 4% of its HHV. The efficiency of 77% HHV is a 25% improvement over steam reforming of the same hydrocarbon.

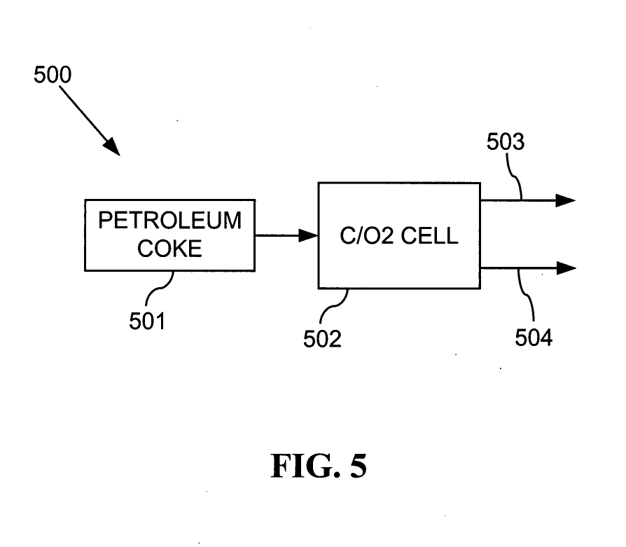

Referring now to FIG. 5, a system 500 will be described for converting petroleum coke 501 into electrical power. The system is designated generally by the reference numeral 500. The petroleum coke 501 is converted to electrical power in a direct conversion fuel cell 502. The direct conversion fuel cell 502 provides a direct carbon conversion fuel cell that generates electric power 503 from the electrochemical reaction of carbon and atmospheric oxygen. The direct conversion fuel cell 502 comprises a fuel cell housing containing an anode and a cathode. A slurry or wetted aggregation is introduced into the fuel cell housing. The slurry comprises carbon immersed in a molten-salt electrolyte. The carbon is immersed in a molten-salt electrolyte consisting of a mixture of molten alkali carbonates (LiK,Na)₂CO₃ to form a slurry, paste or wetted aggregation.

The slurry is introduced into the direct conversion fuel cell 502. The molten salt electrolyte provides a continuous electrolyte of carbon between the porous nickel plate anode current collector and a porous nickel plate cathode that has been converted to NiO doped with Li ions. An inert ceramic separator (e.g., woven alumina or zirconia fibers) saturated with the molten salt may be located between anode and cathode. The anode current collector and the cathode produce an electrical current 503.

The direct conversion fuel cell 504 reactions are as follows:
C+2CO₃²⁻=3 CO₂+4e− anodic half-reaction, at an inert Ni or graphite current collector
O₂+2CO₂+4e⁻=2CO₃²⁻ cathode half-reaction, at a NiO-coated Ni cathode
C+O₂=CO₂ Net cell reaction, sum of the half reactions

The direct conversion fuel cell 502 in one embodiment uses 1-1000 micrometer-sized aggregates of carbon having extremely fine crystalline domains (10- to 1,000-nanometer-diameter) distributed in a mixture of molten lithium, sodium, or potassium carbonate at a temperature of 650 to 850° C. The overall cell reaction is carbon and oxygen (from ambient air) forming carbon dioxide 504 and electrical power 503. The reaction yields 80 percent of the carbon-oxygen combustion energy as electrical power. It provides 1-2 kilowatt of power per square meter of cell surface area—a rate sufficiently high for practical applications. Yet no burning of the carbon takes place.

The direct conversion fuel cell 502 is refueled by, for example, entrainment of the fine carbon particles into the cell housing in a gas such as carbon dioxide or nitrogen in such a manner that the carbon particles are immediately wetted by the molten salt upon contact and thus wetted, remain in electrical contact with the melt until consumed by anodic oxidation. The direct conversion fuel cell 502 provides a method of carbon preparation to allow instant wetting of the particles upon contact with the molten carbonate salt mixture comprising the fuel cell electrolyte.

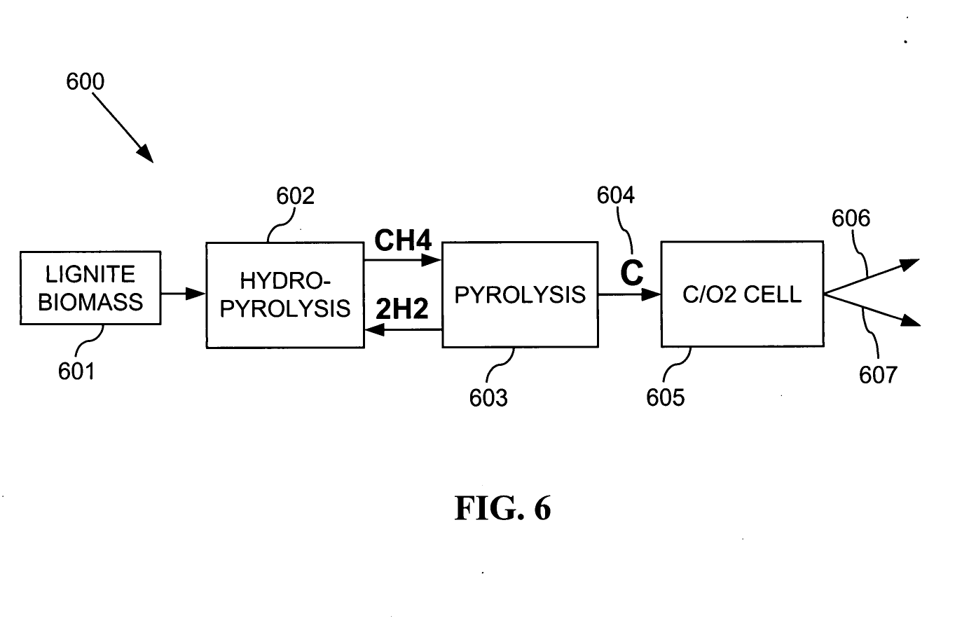

Referring now to FIG. 6, a system 600 will be described for converting lignite, brown coal, bituminous, anthracite or biomass 601 into electrical power. The raw fuel (lignite, biomass, etc.) 601 is decomposed into “C” carbon 604 through hydro-pyrolysis 602 and pyrolysis 603. The carbon 604 is converted to electrical power in a direct conversion fuel cell 605. The hydrogen “2H₂” is recycled to the hydropyrolysis unit.

The direct conversion fuel cell 605 provides a direct carbon conversion fuel cell that generates electric power from the electrochemical reaction of carbon and atmospheric oxygen. The direct conversion fuel cell 605 comprises a fuel cell housing containing an anode and a cathode. A slurry or wetted aggregation is introduced into the fuel cell housing. The slurry comprises carbon 604 immersed in a molten-salt electrolyte. The carbon is immersed in a molten-salt electrolyte consisting of a mixture of molten alkali carbonates such as (LiₐK_{b}Na_{c})₂CO₃ (where (a+b+c)=1) to form a slurry or wetted aggregation.

The slurry is introduced into the direct conversion fuel cell 605. The molten salt electrolyte provides a continuous electrolyte of carbon between the porous nickel plate anode current collector and a porous nickel plate cathode. An inert ceramic separator (e.g., woven or non-woven alumina or zirconia fibers) saturated with the molten salt may be located between anode and cathode. The anode current collector and the cathode produce an electrical current.

The direct conversion fuel cell 605 reactions are as follows:
C+2CO₃²⁻=3 CO₂+4e⁻ anodic half-reaction, at an inert Ni or graphite current collector
O₂+2CO₂+4e⁻=2CO₃²⁻ cathode half-reaction, at a NiO-coated Ni cathode
C+O₂=CO₂ Net cell reaction, sum of the half reactions

The direct conversion fuel cell 605 in one embodiment uses 1-1000 micrometer size aggregates of carbon having small domains of microcrystallinity (10- to 1,000-nanometer-size) and are distributed in a mixture of molten lithium, sodium, or potassium carbonate at a temperature of 750 to 850° C. The overall cell reaction is carbon and oxygen (from ambient air) forming carbon dioxide 607 and electrical power 606. The reaction yields 80 percent of the carbon-oxygen combustion energy as electrical power. It provides 1-2 kilowatt of power per square meter of cell surface area—rates sufficiently high for practical applications. Yet no burning of the carbon takes place.

The direct conversion fuel cell 605 is refueled by, for example, entrainment of the fine carbon particles into the cell housing in a gas such as carbon dioxide or nitrogen in such a manner that the carbon particles are immediately wetted by the molten salt upon contact and thus wetted, remain in electrical contact with the melt until consumed by anodic oxidation. The direct conversion fuel cell 605 provides a method of carbon preparation to allow instant wetting of the particles upon contact with the molten carbonate salt mixture comprising the fuel cell electrolyte.

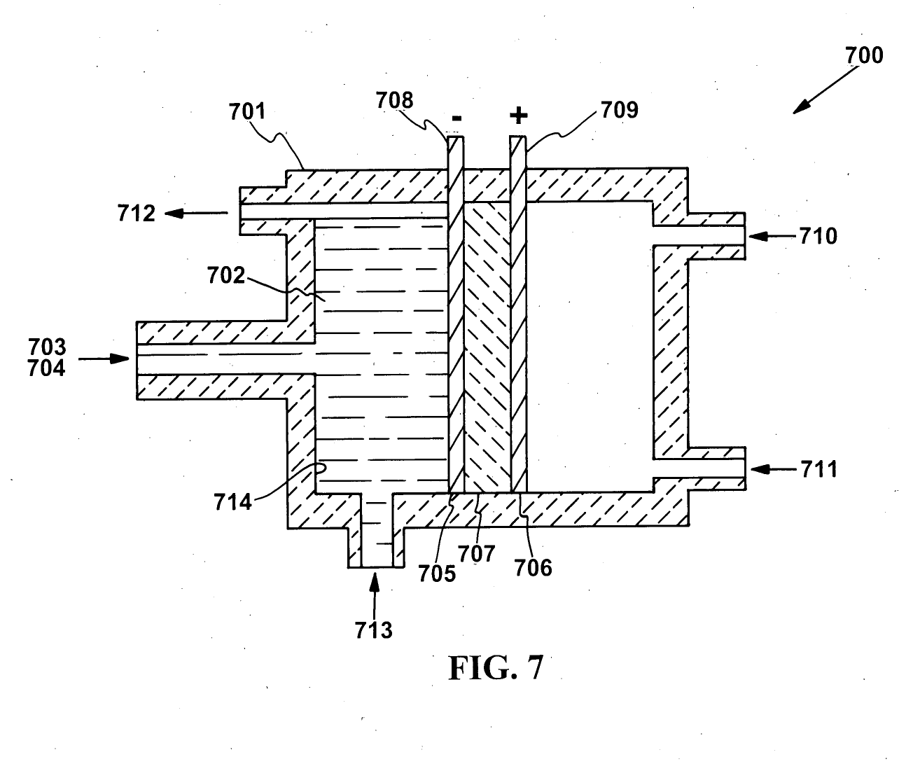

Referring now to FIG. 7, additional details of a direct conversion fuel cell constructed in accordance with the present invention is illustrated. The direct conversion fuel cell is designated generally by the reference numeral 700.

Referring now to FIG. 7, a direct conversion fuel cell constructed in accordance with the present invention is illustrated. The system is designated generally by the reference numeral 700. The system 700 provides a direct carbon conversion fuel cell that generates electric power from the electrochemical reaction of carbon and atmospheric oxygen.

Direct carbon conversion fuel cells provide a method of producing electricity in a fuel cell having an anode and a cathode current collector, an anode fuel consisting of particulates of carbon wetted or contacted with molten salt (mixtures of alkali or alkaline earth carbonates at temperatures above their melting point), and a means of flowing air adjacent to the cathode current collector, this collector being a high surface are porous metal structure made of, for example, sintered nickel particles coated with lithium-doped nickel oxide; silver, copper, gold or other metal providing for the electrochemical reduction of atmospheric oxygen.

The particulate carbon fuels introduced into the fuel cell must become wetted with the molten salt. For some carbon fuels (such as raw coal, petroleum coke, and coked or devolatilized coal), the surfaces are covered with chemical functional groups such as carboxylates, esters, quinoidal, or hydroxyl groups. These groups are readily ionized in the presence of molten salts. In the ionized state, they are chemically compatible with the molten salt and are therefore readily wetted by the salt upon contact between the particles and the molten salt resident in the fuel cell.

Other particulate carbon fuels include very pure carbons such as, for example, (1) very pure carbons produced by pyrolysis of hydrocarbons (such as, for examples, fuel oil, methane, ethane, propane and higher straight or branched alkanes); (2) acetylene black; (3) furnace blacks and carbon blacks; (4) the thermal decomposition products of any saturated hydrocarbon alkane, alkene or alkyne; and (5) carbon aerogels made by thermal decomposition of the base-catalyzed condensation products of resorcinol with formaldehyde. The surfaces of these very pure materials may tend to be free of ionizable functional groups. Therefore wetting will not readily occur upon contact between the carbon and the molten carbonate salt.

The system 700 provides a method for preparing a particulate carbon fuel for the fuel cell and a method of introducing the particulate carbon fuel into the fuel cell in a manner allowing a rapid startup of the electrochemical reaction that produces electric power. The system 700 is useful in preparing particulates of very pure carbon, such as previously described.

A process, called direct carbon conversion, has been convincingly demonstrated. United States Patent Applications No. 2002/0106549 published Aug. 8, 2002 and No. 2003/0017380 published Jan. 23, 2003 by John F. Cooper et al show high temperature, molten electrolyte electrochemical cells for directly converting a carbon fuel to electrical energy. The disclosures of United States Patent Applications Nos. 2002/0106549 and 2003/0017380 are incorporated herein by this reference.

With the system 700, it is possible to introduce into the fuel cell particulates of highly reactive fuels that are made of substantially pure carbon, and allow these particles to rapidly become wetted and begin the electrochemical reaction that produces electric power.

The system 700 enables use of large quantities of carbon blacks produced industrially to be used directly in carbon conversion fuel cells, without laborious and energy intensive mixing of carbon and carbonate.

The system 700 comprises a fuel cell housing 701 containing an anode current collector 705 and a cathode 706. A paste, slurry or wetted aggregation 702 is introduced into the fuel cell housing 701. The paste, slurry, or wetted aggregation of carbon particles 702 comprises carbon particles 704 immersed in a molten-salt electrolyte 703 and contained within the anode chamber part of the cell, 714.

The carbon 704 is in the form of finely divided particles, typical size 100-1000 micrometers, having a reactive nano-structure called “turbostratic.” The carbon particles are immersed in a molten-salt electrolyte 703 consisting of a mixture of molten alkali carbonates (LiₐK_{b}Na_{c})₂CO₃, where (a+b+c)=1, to form a paste, slurry or wetted aggregation of particles.

The slurry 702 is introduced into the fuel cell housing 701. The molten salt electrolyte 703 provides a continuous electrolyte of carbon particles 704 between the porous nickel plate anode current collector 705 and a porous nickel plate cathode 706. An inert ceramic separator 707 (e.g., woven or non-woven alumina or zirconia fibers) saturated with the molten salt may be located between anode 705 and cathode 706. The anode current collector 705 and the cathode 706 produce an electrical potential between the anode lead 708 and the cathode lead 709, from which electrical current may be drawn by closing the circuit through a load (not shown). The fuel cell also provides ports for introduction of air plus carbon dioxide 710 and exhaust of air and unreacted carbon dioxide 711. The fuel cell also provides at least one port for exhaust of carbon dioxide reaction product, 712, from the anode chamber; and for the draining of excess molten carbonate from the anode chamber (or introducing additional molten carbonate into the system), designated by 713.

The fuel cell system 700 reactions are as follows:
C+2CO₃²⁻=3 CO₂+4e⁻ anodic half-reaction, at an inert Ni or graphite current collector
O₂+2CO₂+4e⁻¹=2CO₃²⁻ cathode half-reaction, at a NiO-coated Ni cathode
C+O₂=CO₂ Net cell reaction, sum of the half reactions

The direct conversion fuel cell 605 in one embodiment uses 1-1000 micrometer size aggregates of carbon having small domains of microcrystallinity (10- to 1,000-nanometer-size) and are distributed in a mixture of molten lithium, sodium, or potassium carbonate at a temperature of 750 to 850° C. The overall cell reaction is carbon and oxygen (from ambient air) forming carbon dioxide and electricity. The reaction yields 80 percent of the carbon-oxygen combustion energy as electricity—approximately 7.3 kWh/kg-carbon. It provides typically up to 2 kilowatt of power per square meter of cell surface area—a rate sufficiently high for practical applications. Yet NO direct combustion of the carbon takes place. Electrochemical losses within the cell also produce nearly 2 kWh of thermal energy that is evolved as waste heat, per kilogram of carbon consumed by the fuel cell.

The fuel cell 700 is refueled by, for example, entrainment of the fine carbon particles 704 into the cell housing 701 in a gas such as carbon dioxide or nitrogen in such a manner that the carbon particles 704 are immediately wetted by the molten salt upon contact with the ambient molten salt within the anode chamber, and thus wetted, remain in electrical contact with the melt until consumed by anodic oxidation.

The system 700 has uses in efficient electric power generation and in broad mobile, transportable and stationary applications. The system 700 also has uses in electric power generation at high efficiencies from coal, petroleum derived fuels, petroleum coke, and natural gas. The system 700 can help to conserve precious fossil resources by allowing more power to be harnessed from the same amount of fuel, can help improve the environment by substantially decreasing the amount of pollutants emitted into the atmosphere per kilowatt-hour of electrical energy that is generated, and can help decrease emissions of carbon dioxide, which are largely responsible for global warming.

The carbon-air fuel cell gives off a pure stream of carbon dioxide through port 712 that can be captured without incurring additional costs of collection and separation, as required from the exhausts of smoke stacks. The stream of carbon dioxide, already only a fraction of current processes, can be sequestered or used for oil and gas recovery through existing pipelines. Pyrolysis—the thermal decomposition method used to turn hydrocarbons into hydrogen and small carbon particles used in direct carbon conversion—consumes less energy and requires less capital than the electrolysis or steam-reforming processes required to produce hydrogen-rich fuels. Pyrolysis produces millions of tons of carbon blacks annually in the U.S. Carbon black is a disordered form of carbon produced by thermal or oxidative decomposition of hydrocarbons and is used to manufacture many different products, including tires, inks, and plastic fillers. A large fraction of the annual production is “off spec”—meaning unsuitable for applications requiring specific size, color, functional groups, conductivity, etc., and is available as a low cost fuel.

The system 700 has uses in efficient electric power generation and in broad mobile, transportable and stationary applications. The system 700 also has uses in electric power generation at high efficiencies from coal, petroleum derived fuels, petroleum coke, and natural gas. The system 700 can help to conserve precious fossil resources by allowing more power to be harnessed from the same amount of fuel, can help improve the environment by substantially decreasing the amount of pollutants emitted into the atmosphere per kilowatt-hour of electrical energy that is generated, and can help decrease emissions of carbon dioxide, which are largely responsible for global warming.

The system 700 can use fuel derived from many different sources, including coal, lignite, petroleum, natural gas, and even biomass (peat, rice hulls, corn husks). At the present time 90 percent of Earth's electric energy comes from the burning of fossil fuels. Half of our fossil-fuel resources is coal, and 80 percent of the coal belongs to the United States and Canada, the former Soviet Union, and China. Coal-fired plants produce 55 percent of U.S. electricity—as well as large amounts of pollutants. As a result, the vast energy reserves of coal remain underused. Direct carbon conversion has the potential to be the long-sought “clean coal” technology.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A hybrid power generation apparatus for generating electrical power from a hydrocarbonaceous fuel, comprising:
a pyrolysis unit for pyrolyzing the hydrocarbonaceous fuel to form carbon and hydrogen,
a direct conversion fuel cell for converting said carbon into electrical power, and
a solid oxide fuel cell, molten carbonate fuel cell, PEM fuel cell, or alkaline hydrogen fuel cell, for converting said hydrogen into electrical power.

2. The hybrid power generation apparatus of claim 1 wherein said direct conversion fuel cell generates electric power from the electrochemical reaction of carbon and atmospheric oxygen.

3. The hybrid power generation apparatus of claim 1 wherein said direct conversion fuel cell includes an anode and a cathode.

4. The hybrid power generation apparatus of claim 1 wherein said direct conversion fuel cell includes a slurry of said carbon in a molten-salt electrolyte.

5. The hybrid power generation apparatus of claim 1 wherein said direct conversion fuel cell includes a wetted aggregation of said carbon in a molten-salt electrolyte.

6. The hybrid power generation apparatus of claim 1 wherein said carbon is natural gas, petroleum clathrate CH₄, and said direct conversion fuel cell converts said natural gas, petroleum, clathrate CH₄, into electrical power.

7. The hybrid power generation apparatus of claim 1 wherein said carbon is petroleum coke and said direct conversion fuel cell converts said petroleum coke into electrical power.

8. The hybrid power generation apparatus of claim 1 wherein said carbon is lignite biomass and said direct conversion fuel cell converts said lignite biomass into electrical power.

9. The hybrid power generation apparatus of claim 1 wherein said solid oxide fuel cell includes a water condenser.

10. The hybrid power generation apparatus of claim 1 wherein said solid oxide fuel cell includes a hard ceramic electrolyte.

11. A hybrid power generation apparatus for generating electrical power from a hydrocarbonaceous fuel, comprising:
pyrolysis means for pyrolyzing the hydrocarbonaceous fuel to form carbon and hydrogen,
direct conversion fuel cell means for converting said carbon into electrical power, and
solid oxide fuel cell means for converting said hydrogen into electrical power.

12. The hybrid power generation apparatus of claim 11 wherein said direct conversion fuel cell means includes means for generating electric power from the electrochemical reaction of carbon and atmospheric oxygen.

13. The hybrid power generation apparatus of claim 11 wherein said direct conversion fuel cell means includes an anode and a cathode.

14. The hybrid power generation apparatus of claim 11 wherein said direct conversion fuel cell means includes means for forming a slurry or wetted aggregate of said carbon in a molten-salt electrolyte.

15. The hybrid power generation apparatus of claim 11 wherein said direct conversion fuel cell means includes means for forming a wetted aggregation of said carbon in a molten-salt electrolyte.

16. The hybrid power generation apparatus of claim 11 wherein said carbon is natural gas, petroleum clathrate CH₄, and said direct conversion fuel cell means converts said natural gas, petroleum clathrate CH₄, into electrical power.

17. The hybrid power generation apparatus of claim 11 wherein said carbon is petroleum coke and said direct conversion fuel cell means converts said petroleum coke into electrical power.

18. The hybrid power generation apparatus of claim 11 wherein said carbon is lignite, brown coal, bituminous coal, anthracite, or biomass and said direct conversion fuel cell means converts said lignite biomass into electrical power.

19. The hybrid power generation apparatus of claim 11 wherein said solid oxide fuel cell means includes a water condenser.

20. The hybrid power generation apparatus of claim 11 wherein said solid oxide fuel cell means includes a hard ceramic electrolyte.

21. A process for generating electrical power from a hydrocarbonaceous fuel comprising the steps of:
pyrolyzing the hydrocarbonaceous fuel to form carbon and hydrogen,
introducing the carbon into a direct conversion fuel cell for producing electrical power, and
introducing the hydrogen into a solid oxide fuel cell for producing electrical power,

22. The hybrid process for generating electrical power of claim 21 wherein said direct conversion fuel cell generates electric power from the electrochemical reaction of carbon and atmospheric oxygen.

23. The process for generating electrical power of claim 21 wherein said direct conversion fuel cell converts natural gas, petroleum, clathrate methane CH₄, into electrical power.

24. The process for generating electrical power of claim 21 wherein said direct conversion fuel cell converts petroleum coke into electrical power.

25. The process for generating electrical power of claim 21 wherein said direct conversion fuel cell converts lignite, brown coal, bituminous coal, anthracite, or biomass into electrical power.
